(19) United States
(12) Patent Application Publication
(10) Pub. No.: US 2010/0176177 A1
(43) Pub. Date: Jul. 15, 2010

(54) GAS COMBUSTION TYPE STRIKING TOOL

(75) Inventor: Hiroshi Tanaka, Tokyo (JP)

Correspondence Address: DRINKER BIDDLE & REATH (DC), 1500 K STREET, N.W., SUITE 1100, WASHINGTON, DC, 20005-1209, US

(73) Assignee: Max Co., Ltd., Chuo-ku (JP)

(21) Appl. No.: 12/376,708

(22) PCT Filed: Aug. 3, 2007
(86) PCT No.: PCT/JP2007/065247

§ 371 Date: Feb. 6, 2009

(30) Foreign Application Priority Data
Aug. 9, 2006 (JP) 2006-216831

(51) Int. Cl. B25C 1/14

(52) U.S. Cl. 227/10

(57) ABSTRACT

When a movable sleeve 10 provided in an upper portion of a striking cylinder 5 is vertically moved and contacted with and separated from a cylinder head 8, a combustion chamber 9 is opened and closed. When mixed gas in the combustion chamber 9 is ignited and explosively burned, high gas pressure acts on a striking piston 6, so that the striking piston 6 is driven being given an impact force. When the striking piston 6 is driven, a driver 7 connected to a lower face side of the striking piston 6 strikes a fastener from a nose portion 4 provided in a lower portion of the tool body. A partitioning portion 16, which partitions the striking cylinder 5 and the combustion chamber 9, and a valve mechanism, which opens and closes the partitioning portion 16, are provided. At the time of striking of the striking piston 6 and at the time of returning of the striking piston 6 after a completion of striking the fastener, the valve mechanism is opened.

### TECHNICAL FIELD

The present invention relates to a gas combustion type striking tool for striking a fastener such as a nail or a struck screw, to which power is supplied by combustion. More particularly, the present invention relates to a valve device for controlling an opening and closing motion of a partitioning portion that partitions a striking cylinder and a combustion chamber.

### BACKGROUND ART

In a gas combustion type striking tool, mixed gas obtained when combustible gas and air are agitated and mixed by a fan in a combustion chamber is ignited and explosively burned, and the gas pressure of the thus obtained combustion gas is supplied into a striking cylinder so as to drive a striking piston. (Refer to JP-B-04-048589.)

In the conventional gas combustion type striking tool, the combustion chamber and the striking cylinder are integrally continuous. Therefore, for example, when the striking piston is returned upward after a striking operation has been completed and the striking piston is returned only to an intermediate position for some reasons, a volume of the combustion chamber is expanded to a position to which the striking piston is returned. Even when the volume of the combustion chamber is expanded, a volume of air and mixed gas to be supplied is constant. Therefore, the fuel is diluted and it becomes impossible to ignite the mixed gas in some cases. In this case, it is necessary to disassemble the tool and return the striking piston to a predetermined position with the worker's hands. On the assumption of the occurrence of such a case, a volume of fuel larger than an appropriate volume of fuel for combustion must be always supplied to the tool so that the mixed gas can be ignited even in the case where the volume of the combustion chamber has been expanded.

In the case where air is supplied to the combustion chamber being supercharged by an air compressor so as to increase an internal pressure of the combustion chamber and to obtain a higher output, there is a possibility that the striking piston can not be maintained at a predetermined top dead center position and lowered by the supercharging pressure. Accordingly, in order to strongly hold the striking piston, it is necessary to strengthen a force to return the striking piston upward. However, a returning motion of the striking piston is made by a pressure difference between the decompression caused by the cooling of the combustion chamber after the completion of combustion and the pressure acting on a lower face of the striking piston. Therefore, the decompression of the supercharged combustion gas after the completion of combustion adversely acts on the returning motion of the striking piston.

### DISCLOSURE OF THE INVENTION

One or more embodiments of the present invention provides a valve device of a combustion chamber in a gas combustion type striking tool in which fuel can be supplied into a combustion chamber at an appropriate concentration and further it is possible to positively prevent a striking piston from being lowered by a supercharging pressure.

According to a first aspect of the present invention, in a gas combustion type striking tool of one or more embodiments of the present invention, a striking piston is slidably provided in a striking cylinder arranged in a tool body. A combustion chamber provided in an upper portion of the striking cylinder is can be opened and closed. When mixed gas, in which combustible gas and air are mixed with each other, is explosively burned in the combustion chamber being ignited by an ignition plug arranged in a cylinder head, high gas pressure acts on the striking piston so that the striking piston is driven being given an impact force. Then, a driver connected to a lower face side of the striking piston strikes a fastener from a nose portion provided in a lower portion of the tool body. At an upper end of the striking cylinder, a partitioning portion for partitioning the striking cylinder and the combustion chamber is provided. A valve mechanism for opening and closing this partitioning portion is provided. At the time of driving the striking piston and at the time of returning of the striking piston after a fastener has been stricken, the valve mechanism is opened.

According to a second aspect of the present invention, in the gas combustion type striking tool of the first aspect, the valve mechanism includes: a cylinder valve normally urged by a spring so that the combustion chamber and the striking cylinder are closed, and opened against a spring force of the spring when an internal pressure in the combustion chamber is higher than an internal pressure in the striking cylinder; and a check valve normally urged by a spring so that the combustion chamber and the striking cylinder is closed and opened against the spring force when the internal pressure in the striking cylinder is higher than the internal pressure in the combustion chamber.

According to a third aspect of the present invention, in the gas combustion type striking tool of the first aspect, the valve mechanism includes: a cylinder valve normally urged by a spring so that the combustion chamber and the striking cylinder is closed, opened against a spring force of the spring when an internal pressure in the combustion chamber is higher than an internal pressure in the striking cylinder; a hook member capable of engaging with the cylinder valve; and a pushing member for pushing the hook member at the time of striking so that the hook member is engaged with the cylinder valve, separating from the hook member after the completion of striking.

According to a fourth aspect of the present invention, in the gas combustion type striking tool of the first aspect, the valve mechanism includes a cylinder valve for opening and closing the combustion chamber and the striking cylinder, wherein the valve mechanism electrically controls an operation of the cylinder valve so that the cylinder valve can be linked with the combustion in the combustion chamber and the returning motion of the striking cylinder after the completion of striking.

According to the gas combustion type striking tool of the first aspect, the partitioning portion for partitioning the striking cylinder and the combustion chamber is provided at an upper end of the striking cylinder and the valve mechanism for opening and closing this partitioning portion is provided. At the time of driving the striking piston and at the time of returning of the striking piston after the completion of striking the fastener, the valve mechanism is operated being opened. Therefore, at the time of driving the striking piston, the combustion chamber and the striking cylinder are communicated with each other. Therefore, gas pressure generated in the combustion chamber is supplied into the striking cylinder. Accordingly, the striking cylinder is driven. After the completion of striking, the combustion chamber and the striking cylinder are communicated with each other. Therefore, the striking piston can be positively returned to the initial position.

As described above, by the partitioning portion, a volume in the combustion chamber can be always kept constant irrespective of the position of the striking piston and the mixed gas in the combustion chamber can be maintained at a constant appropriate concentration. Accordingly, even when the striking piston can not be sufficiently returned to the initial position, a predetermined pressure is given to the striking piston so that the striking piston can be moved to the bottom dead center and at the time of cooling, the striking piston can be returned to the top dead center again.

In the case where the combustion chamber is supercharged by using a supercharger, although pressure in the combustion chamber is increased, the valve mechanism is not operated and the valve is not opened. Accordingly, the striking piston does not receive pressure from the combustion chamber. Therefore, it is possible to positively prevent the striking piston from being lowered by the supercharging pressure.

According to the gas combustion type striking tool of the second aspect, the valve mechanism for opening and closing the partitioning portion, which partitions the striking cylinder and the combustion chamber, includes: a cylinder valve normally urged by a spring so that the combustion chamber and the striking cylinder can be closed and opened against a spring force of the spring when an internal pressure in the combustion chamber is higher than an internal pressure in the striking cylinder; and a check valve normally urged by a spring so that the combustion chamber and the striking cylinder can be closed and opened against the spring force when the internal pressure in the striking cylinder is higher than the internal pressure in the combustion chamber. Therefore, the valve structure is simple and the number of parts of the valve structure can be reduced to the minimum.

According to the gas combustion type striking tool of the third aspect, the valve mechanism includes: a cylinder valve, normally urged by a spring so that the combustion chamber and the striking cylinder can be closed and opened against a spring force of the spring when an internal pressure in the combustion chamber is higher than an internal pressure in the striking cylinder; a hook member capable of engaging with the cylinder valve; and a pushing member for pushing the hook member at the time of striking so that the hook member can be engaged with the cylinder valve and separating from the hook member after the completion of striking. Accordingly, at the time of striking, the hook member engages with the cylinder valve, and, after the completion of striking, the engagement is released. Accordingly, since the cylinder valve is mechanically operated by the hook member, the valve can be positively opened and closed.

According to the gas combustion type striking tool of the fourth aspect, the valve mechanism electrically controls an operation of the cylinder valve so that the cylinder valve can be linked with the combustion in the combustion chamber and the returning motion of the striking cylinder after the completion of striking by the striking cylinder. Therefore, a period of time, in which the striking piston is once reciprocated from one ignition time to the return to the top dead center, is previously measured and the cylinder valve is electrically opened being a little delayed from the ignition time and the cylinder valve can be electrically closed at the point of time at which a predetermined setting time has passed from the ignition time.

The gas combustion type striking tool is necessarily equipped with a battery so as to ignite the ignition plug and rotate the fan. Therefore, by using this battery, the cylinder valve can be electrically operated. Therefore, it is unnecessary to provide another electric power source. Accordingly, the entire structure can be made compact. Since the motor, the pinion and so forth are accommodated in the tool body, these parts are not affected by dust generated at the time of working. Therefore, failure is seldom caused.

Other aspects and advantages of the invention will be apparent from the following description, the drawings and the claims.

### BRIEF DESCRIPTION OF THE DRAWINGS

FIG. 1 is a longitudinal sectional view showing a gas combustion type nailing machine of a first exemplary embodiment.

FIG. 2 is a longitudinal sectional view showing a primary portion at the time of nailing executed by the above gas combustion type nailing machine.

FIG. 3 is a longitudinal sectional view showing an operation form after the completion of nailing executed by the above gas combustion type nailing machine.

FIG. 4 is a longitudinal sectional view showing an initial state of a valve mechanism in a second exemplary embodiment.

FIG. 5 is a longitudinal sectional view showing a primary portion of a state in which a contact member is pushed into a workpiece into which a nail is struck.

FIG. 6 is a longitudinal sectional view showing a primary portion at the time of nailing.

FIG. 7 is a longitudinal sectional view showing a primary portion at the time of the completion of nailing.

FIG. 8 is a longitudinal sectional view showing a primary portion in which a form of operation after the completion of nailing is shown.

FIG. 9 is a longitudinal sectional view showing an initial state of a valve mechanism in a third exemplary embodiment.

FIG. 10 is a longitudinal sectional view showing a primary portion at the time of nailing.

### DESCRIPTION OF THE REFERENCE NUMERALS AND SIGNS

4 Nose portion
5 Striking cylinder
6 Striking piston
9 Combustion chamber
8 Cylinder head
10 Movable sleeve
16 Partitioning portion
18 Cylinder valve
20 Check valve

### BEST MODE FOR CARRYING OUT THE INVENTION

### First Exemplary Embodiment

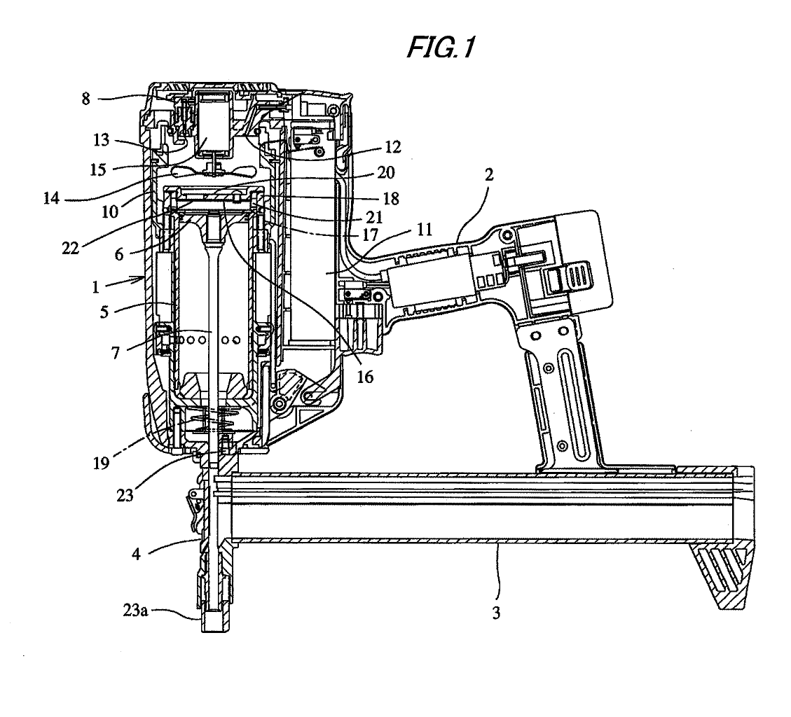

In FIG. 1, reference numeral 1 designates a tool body of a gas combustion type striking tool (a nailing machine). The grip 2 and the magazine 3 are connected to this tool body 1 and the striking piston-cylinder mechanism is provided in the tool body 1. In a lower portion of the tool body 1, the nose portion 4, from which a fastener is struck, is provided.

The striking piston-cylinder mechanism is composed in such a manner that the striking piston 6 is slidably accommodated in the striking cylinder 5 and the driver 7 is integrally connected to a lower portion of the striking piston 6.

Between an upper portion of the striking cylinder 5 and the cylinder head 8 arranged inside of the upper portion of the tool body 1, the cylindrical movable sleeve 10 is arranged being capable of moving in the vertical direction. When the movable sleeve 10 is moved upward and contacted with a lower face of the cylinder head 8, the closed combustion chamber 9, the upper portion of which is closed by the cylinder head 8 and the lower portion of which is closed by the striking cylinder 5 and the striking piston 6, is formed in the movable sleeve 10.

The injection nozzle 12 communicated with the gas container 11 and the ignition plug 13 for igniting mixed gas so as to burn it are arranged in the cylinder head 8. In an upper portion of the tool body 1, the rotary fan 14 is arranged which agitates combustible gas injected into the combustion chamber 9 and mixes the combustible gas with air so as to generate mixed gas of a predetermined air/fuel ratio. Reference numeral 15 designates a motor for the fan.

In this connection, the partitioning portion 16, which partitions the striking cylinder 5 and the combustion chamber 9, and the valve mechanism, which opens and closes the partitioning portion 16, are provided in an upper portion of the striking cylinder 5.

The valve mechanism includes: a cylinder valve 18 which is normally urged by the spring 17 so that it can close the combustion chamber 9 and the striking cylinder 5 and opened against a spring force of the spring 17 when an internal pressure in the combustion chamber 9 is higher than an internal pressure in the striking cylinder 5; and a check valve 20 which is normally urged by the spring so that the combustion chamber 9 and the striking cylinder 5 can be closed and opened only when the internal pressure in the striking cylinder 5 is higher than the internal pressure in the combustion chamber 9.

The cylinder valve 18 is formed into an annular shape and slidably arranged along an outside face of the striking cylinder 5 including the opening portion 21 so that the opening portions 21, which are formed at regular intervals in an upper end side portion of the striking cylinder 5, can be opened and closed. The cylinder valve 18 is normally urged by the spring 17 in a direction in which the opening portion 21 is closed. A spring force of the spring 17 is set at a value at which a closed state of the cylinder valve 18 can not be maintained when the internal pressure in the combustion chamber 9 is increased by combustion.

The upper opening portion 22 is formed in the partitioning portion 16 and the check valve 20, which is operated by a leaf spring, is arranged in the upper opening portion 22. By the action of this check valve 20, the upper opening portion 22 is normally urged by a spring force so that the combustion chamber 9 and the striking cylinder 5 can be closed. Only when an internal pressure in the striking cylinder 5 is higher than an internal pressure in the combustion chamber 9, the upper opening portion 22 is opened.

In this connection, the contact member 23 is arranged so that it can be slid in the nailing direction along the nose portion 4. The tip portion 23a of the contact member 23 is urged by the spring 19 so that it can be normally protruded from the nose portion 4. An upper portion of the contact member 23 is connected to a lower end portion of the movable sleeve 10 through a link member not shown.

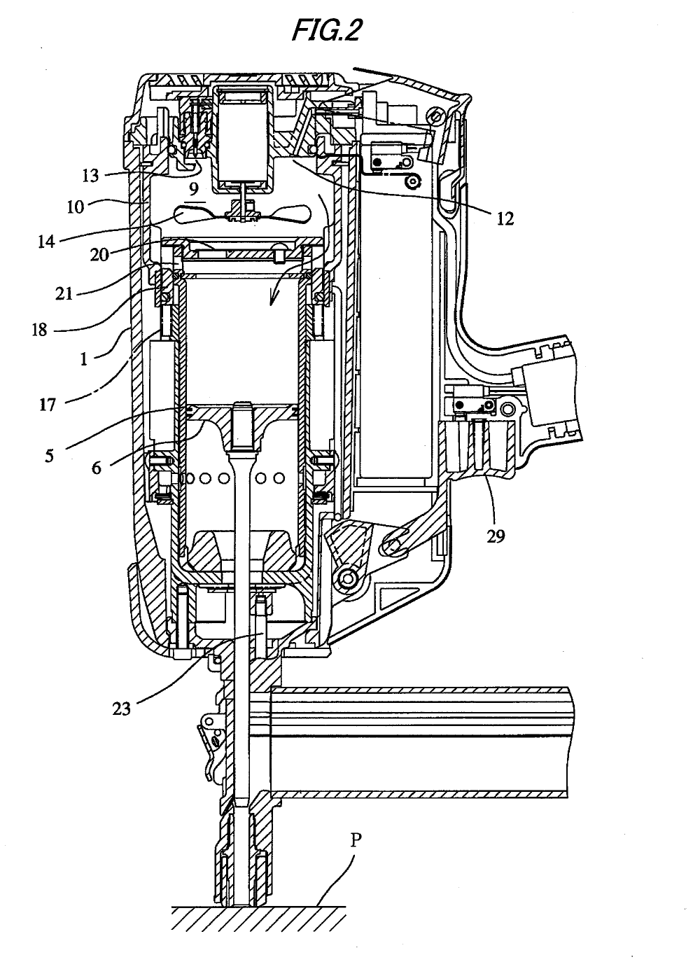

In the above structure, when a nail is struck, as shown in FIG. 2, the contact member 23 is strongly pressed against the workpiece P to which the nail is struck and the contact member 23 and the link member are relatively moved upward with respect to the tool body 1. Accordingly, the movable sleeve 10 is moved upward until it comes into contact with the cylinder head 8 and the closed combustion chamber 9 is formed. At the same time, combustible gas is injected into the combustion chamber 9 from the injection nozzle 12 and the rotary fan 14 is rotated so as to agitate and mix the combustible gas and air. After that, the trigger 29 is pulled and the ignition plug 13 is ignited so as to burn the combustible gas explosively. Due to the foregoing, the internal pressure in the combustion chamber 9 is suddenly raised. Accordingly, the cylinder valve 18 is lowered against a spring force of the spring 17 and gas of high pressure is supplied from the opening portion 21 into the striking cylinder 5 and the striking piston 6 is driven.

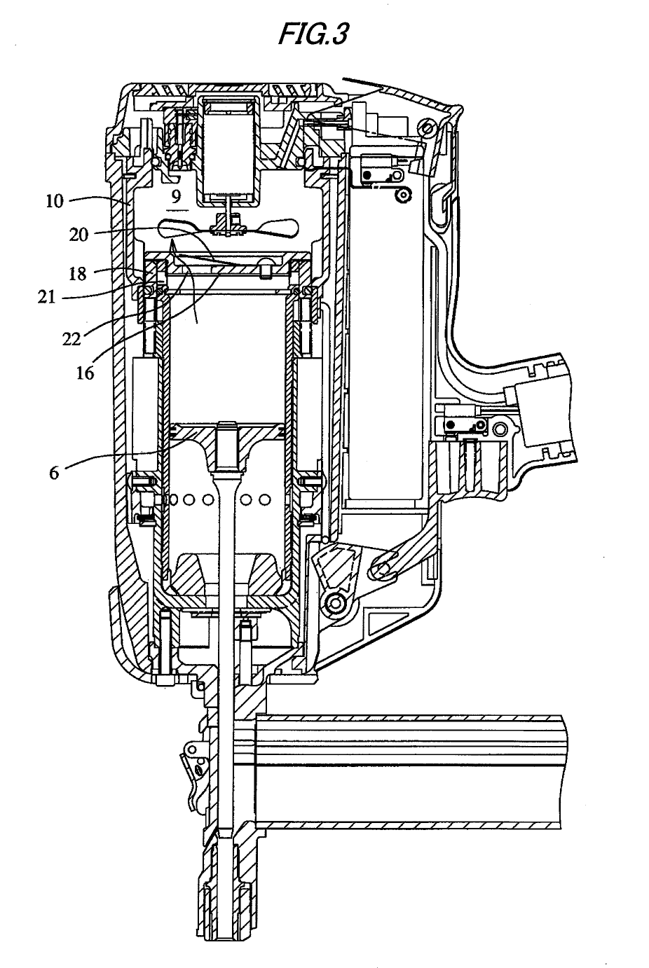

On the other hand, after the striking operation has been completed, the combustion gas is cooled and the pressure in the upper portion of the striking piston 6 is decreased. Therefore, as shown in FIG. 3, the cylinder valve 18 is moved upward and the opening portion 21 is closed. At the same time, the check valve 20 is opened by a pressure difference between the upper portion and the lower portion of the partitioning portion 16. Therefore, the striking piston 6 is returned upward. The pressure in the striking cylinder 5 is released from the upper opening portion 22 into the combustion chamber 9. Accordingly, the striking piston 6 can be positively returned to the top dead center. After that, when the contact member 23 is separated from the workpiece to which a nail is struck, as shown in FIG. 1, the contact member 23 and the link member are relatively moved downward with respect to the tool body 1. Accordingly, the movable sleeve 10 is also moved downward and the combustion chamber 9 is opened and fresh air enters from an upper portion. Combustion gas is discharged form a lower portion. In this way, preparation is made for the next striking operation.

As described above, the partitioning portion 16 is provided which partitions the striking cylinder 5 and the combustion chamber 9. The valve mechanism for opening and closing this partitioning portion 16 includes: a cylinder valve 18 normally urged by a spring so that the combustion chamber 9 and the striking cylinder 5 can be closed, opened against a spring force of the spring 17 when an internal pressure in the combustion chamber 9 is higher than an internal pressure in the striking cylinder 5; and a check valve 20 normally urged by a spring so that the combustion chamber 9 and the striking cylinder 5 can be closed, opened against the spring force when the internal pressure in the striking cylinder 5 is higher than the internal pressure in the combustion chamber 9. As described above, a volume in the combustion chamber 9 can be always kept constant irrespective of the position of the striking piston and the mixed gas in the combustion chamber 9 can be maintained at a constant appropriate concentration. Accordingly, even when the striking piston 6 can not be sufficiently returned to the initial position, a predetermined pressure is given to the striking piston 6 so that the striking piston 6 can be moved to the bottom dead center and at the time of cooling, the striking piston 6 can be returned to the top dead center again.

In the case where the combustion chamber 9 is supercharged by using a supercharger, pressure in the combustion chamber 9 is raised, however, the cylinder valve 18 is not opened in this case. Accordingly, the striking piston 6 does not receive pressure from the combustion chamber 9. Therefore, it is possible to positively prevent the striking piston 6 from being lowered by the supercharging pressure.

Further, since the structure is simple, the number of parts can be reduced to the minimum.

### Second Exemplary Embodiment

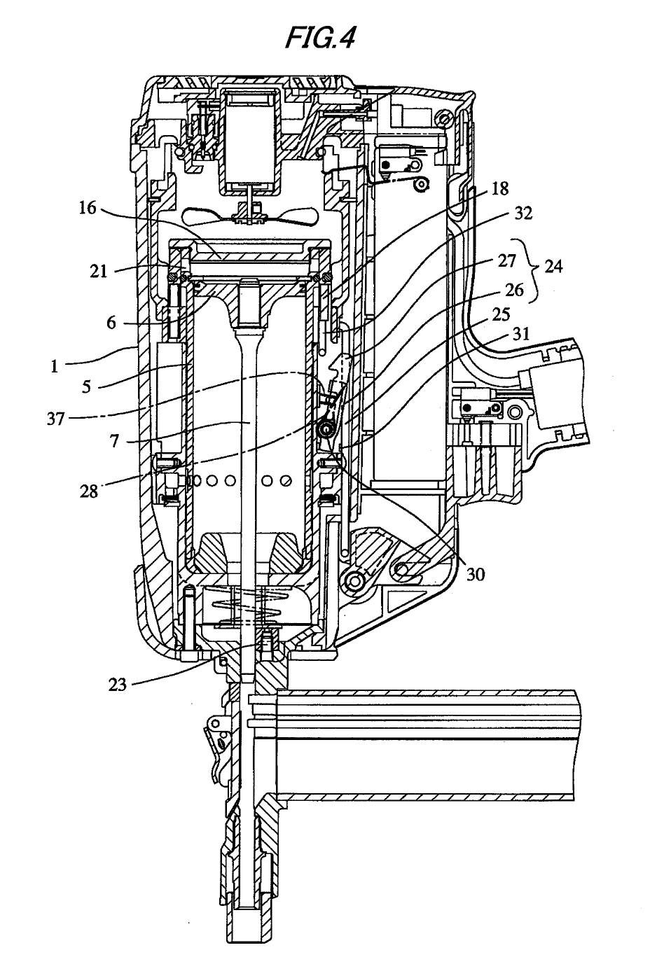

FIGS. 4 to 8 are views showing a valve mechanism of a second exemplary embodiment. The same reference marks are used to indicate the same parts in the first and the second exemplary embodiments.

This valve mechanism includes: a cylinder valve 18 shown in the above description; a hook member 24 provided outside the striking cylinder 5; and a lockout bar 25 linked with the contact member 23.

The hook member 24 is composed in such a manner that the hook base 26 and the hook 27 are connected to each other by the helical spring 28. This hook member 24 is pivotally supported by the same spindle 30 provided in the tool body 1. The hook base 26 is urged so that an upper portion of the hook base 26 can fall backward by an action of the coil spring 37. The hook base 26 and the hook 27 are operated by the helical spring 28 being integrated with each other into one body. An upper portion of the hook member 24 is normally inclined backward.

The lockout bar 25 is operated integrally with the contact member 23. An upper end of the lockout bar 25 is connected to a lower end of the movable sleeve 10. On the hook member 24 side of the intermediate portion of the lockout bar 25, the protruding portion 31, which is a pushing member, is formed. Accordingly, the protruding portion 31 is moved in the vertical direction together with the lockout bar 25. When the protruding portion 31 is moved upward, it pushes a back of the hook base 26 so as to make an engagement.

In this connection, the U-shaped lock bar 32 is attached to a lower portion of the cylinder valve 18.

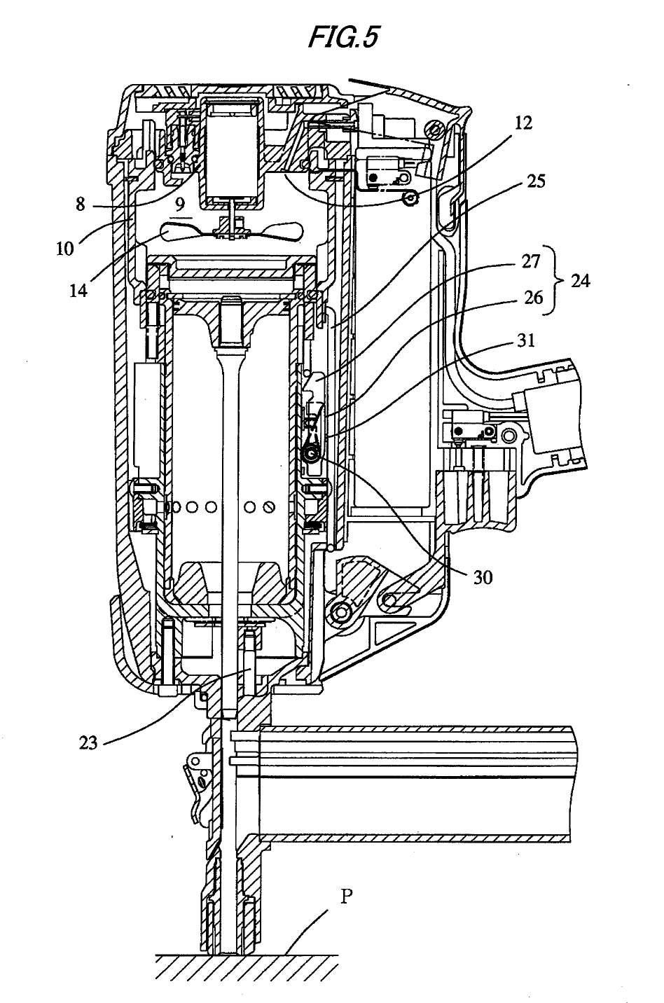

In the above structure, when a nail is struck, as shown in FIG. 5, the contact member 23 is strongly pressed against the workpiece P to which the nail is struck. Due to the foregoing, the movable sleeve 10 is moved upward until it comes into contact with the cylinder head 8. Due to the foregoing, the closed combustion chamber 9 is formed. At the same time, combustible gas is injected from the injection nozzle 12 into the combustion chamber 9 and the rotary fan 14 is rotated so as to agitate and mix the combustible gas with air. At the same time, the lockout bar 25 is moved upward together with the contact member 23. Accordingly, the protruding portion 31 is engaged with the back of the hook base 26 of the hook member 24. Therefore, the hook member 24 is rotated on the striking cylinder 5 side round the spindle 30.

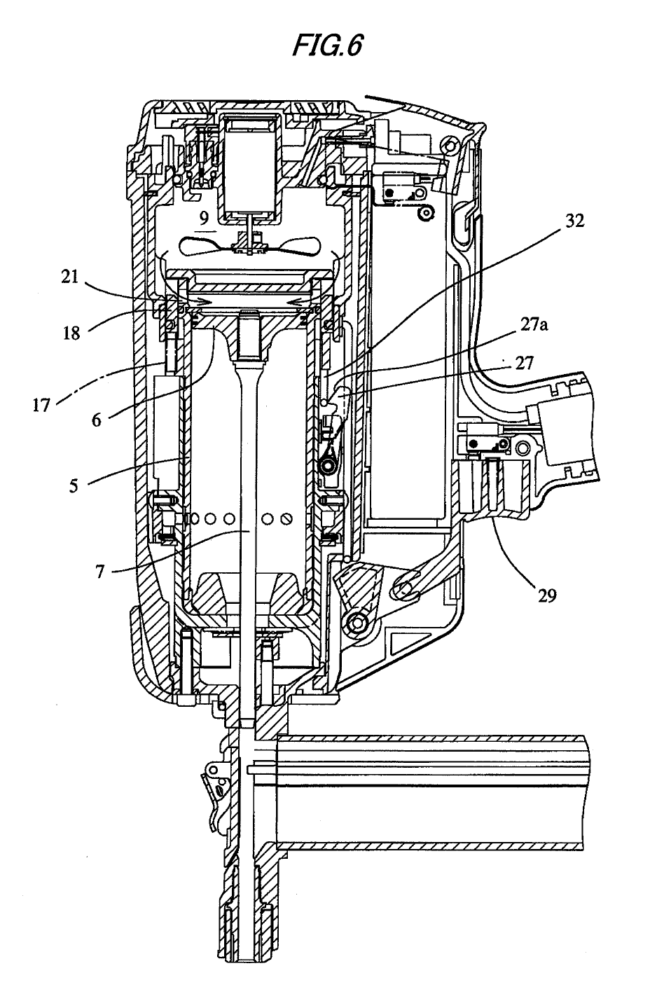

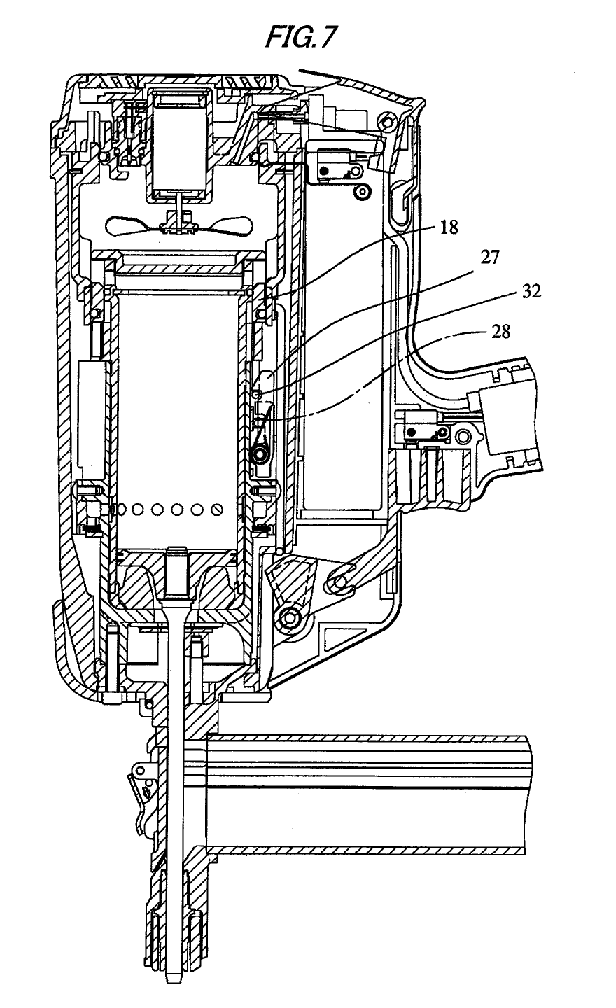

As shown in FIG. 6, when the trigger 29 is pulled and the mixed gas in the combustion chamber 9 is explosively burned, the internal pressure in the combustion chamber 9 is suddenly raised. Accordingly, the cylinder valve 18 is lowered against a spring force of the spring 17 and gas of high pressure is supplied from the opening portion 21 into the striking cylinder 5 and the striking piston 6 is driven. When the cylinder valve 18 is lowered, the U-shaped lock bar 32 is also moved downward and contacted with the inclination face 27a of the hook 27. Accordingly, the hook 27 is pushed away. After the lock bar 32 has passed through the hook 27 as shown in FIG. 7, the hook 27 is returned again by an action of the helical spring 28 and engaged with the lock bar 32. Due to the foregoing, the cylinder valve 18 is locked at the bottom dead center and the opening portion 21 is maintained in an open state.

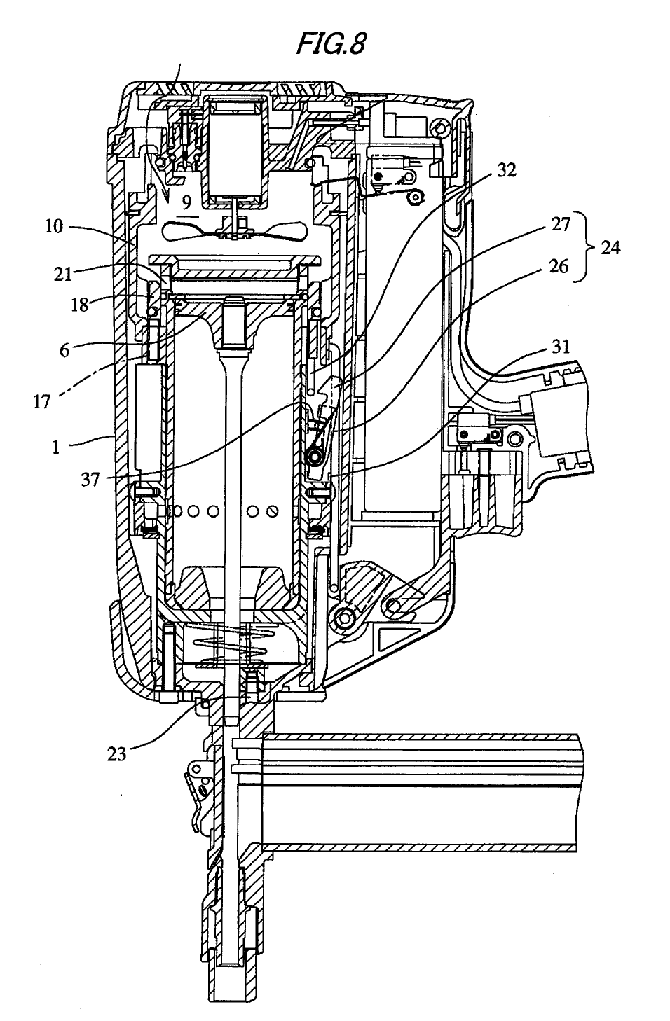

After the completion of striking a nail, the combustion gas is cooled and an upper portion of the striking piston 6 is decompressed and the cylinder valve 18 is maintained being opened. Therefore, the striking piston 6 can be positively returned to the top dead center. When the contact member 23 is separated from the workpiece to which the nail is struck, the contact member 23 is relatively moved downward with respect to the tool body 1 and the protruding portion 31 is also moved downward. Therefore, as shown in FIG. 8, a pushing force given to the hook base 26 is released and the hook member 24 is inclined backward by the coil spring 37 and the hook 27 is disengaged from the lock bar 32. Accordingly, the cylinder valve 18 is moved upward by the spring 17 and closes the opening portion 21. Then, fresh air enters the combustion chamber 9 and the combustion gas is discharged from a lower portion. In this way, preparation is made for the next striking operation.

As described above, in this valve mechanism, the hook member 24 is provided which is linked with the contact member 23 normally protruding from the nose portion 4 and relatively moving upward with respect to the tool body 1 when the contact member 23 is pressed against the workpiece to which the nail is pressed, at the time of striking a nail. When the contact member 23 is moved upward, the hook member 24 is engaged with the opened cylinder valve 18 so as to maintain an open state. When the contact member 23 is moved downward, an engagement of the hook member 24 with the cylinder valve 18 is released. Due to the above structure, the cylinder valve 18 is mechanically operated by the hook member 24. Accordingly, the opening and closing operation can be positively executed.

In this connection, in the second exemplary embodiment, explanations are made into the mechanism including the lockout bar 25, which is linked with the contact member, and the protrusion 31 (the pushing member). However, it is possible to employ a mechanism in which the lockout bar is linked with the trigger and the hook member is pushed by pulling the trigger.

### Third Exemplary Embodiment

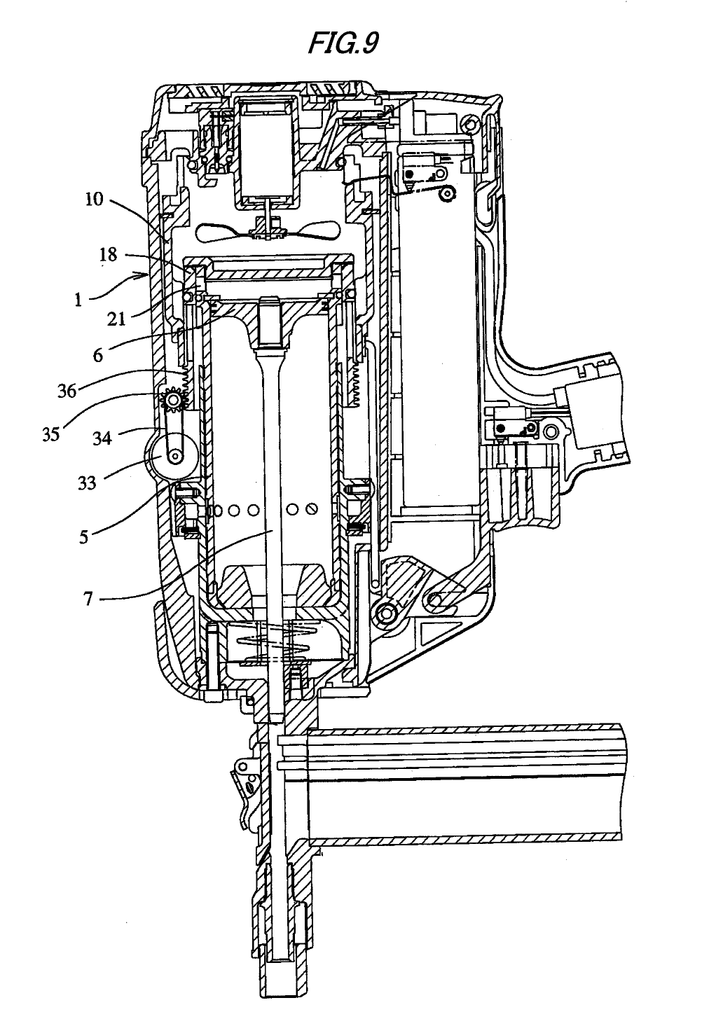

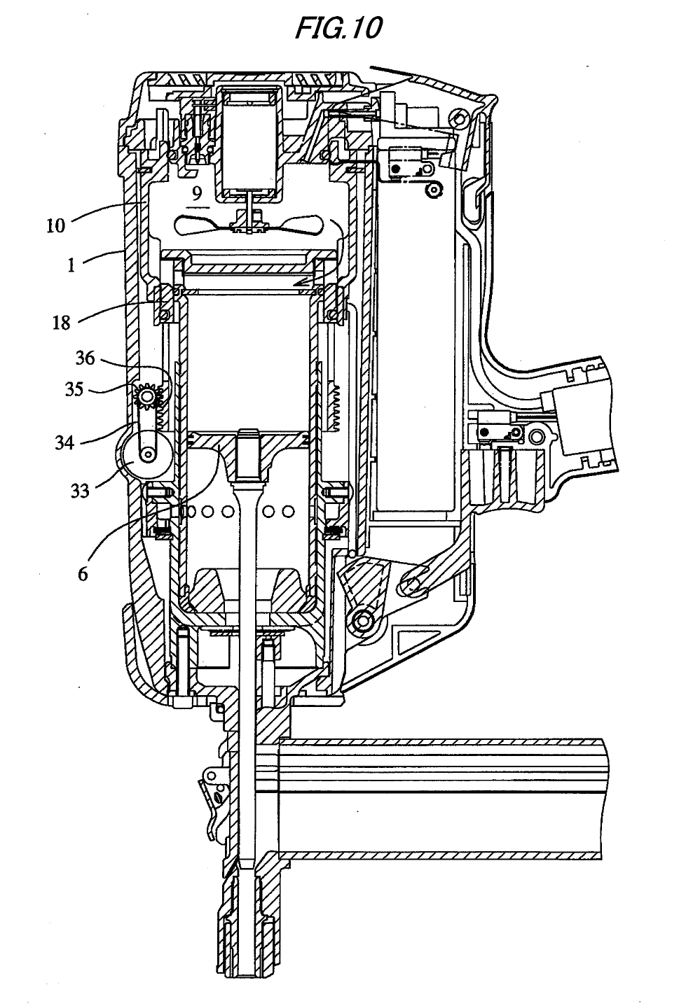

FIGS. 9 and 10 are view showing a valve mechanism of a third exemplary embodiment. The same reference marks are used to indicate the same parts in the first, the second and the third exemplary embodiments.

In this valve mechanism, the cylinder valve 18, which opens and closes the combustion chamber 9 and the striking cylinder 5, is electrically controlled so that the cylinder valve 18 can be linked with the combustion in the combustion chamber 9 and also linked with the returning motion after the completion of striking a nail by the striking cylinder 5. Therefore, in the tool body 1, the electric motor 33 is provided in a front portion of the striking cylinder 5. An output shaft of this electric motor 33 is connected to the pinion 35 through the transmission belt 34. The pinion 35 is meshed with the rack 36. The rack 36 is formed and extended under the cylinder valve 18.

According to the above constitution, when the electric motor 33 is normally and reversely rotated, the cylinder valve 18 can be closed as shown in FIG. 9 and opened as shown in FIG. 10. Accordingly, a period of time from the time of one ignition to the time of returning to the top dead center after the striking piston 6 has been reciprocated once is previously measured and set. Then, the electric motor 33 is operated being a little delayed from the ignition timing so as to open the cylinder valve 18. At the point of time at which the setting time has passed from the ignition time, the electric motor 33 is reversed so that the cylinder valve 18 can be closed.

The gas combustion type striking tool is necessarily equipped with a battery so as to ignite the ignition plug and rotate the fan. Therefore, by using this battery, the electric motor 33 can be electrically operated. Therefore, it is unnecessary to provide another electric power source. Accordingly, the entire structure can be made compact. Since the motor 33, the pinion 35 and so forth are accommodated in the tool body 1, these parts are not affected by dust generated at the time of working. Therefore, failure is seldom caused.

In this connection, instead of the electric motor 33, a solenoid may be used and the cylinder valve 18 may be controlled being opened and closed by a magnetic force.

The present invention has been explained above referring to the specific embodiments. However, it should be noted that variations can be made by those skilled in the art without departing from the spirit and the scope of the present invention.

The present application is based on the Japanese Patent Application (Patent Application 2006-216831) filed on Aug. 9, 2006 and the contents are taken in here for reference.

### INDUSTRIAL APPLICABILITY

The present invention is applicable to a gas combustion type striking tool for striking a fastener such as a nail or a struck screw, to which power is supplied by combustion.

1. A gas combustion type striking tool comprising:
a striking cylinder arranged in a tool body;
a striking piston arranged in the striking cylinder to be capable of sliding in a vertical direction;
a combustion chamber arranged in an upper portion of the striking cylinder;
an ignition plug arranged in a cylinder head;
a driver connected to a lower face side of the striking piston;
a partitioning portion for partitioning the striking cylinder and the combustion chamber and arranged at an upper end of the striking cylinder; and
a valve mechanism for opening and closing the partitioning portion,
wherein the valve mechanism is opened at the time of striking of the striking piston and also at the time of a returning motion after a completion of striking a fastener.

2. The gas combustion type striking tool according to claim 1,
wherein the valve mechanism includes:
a cylinder valve normally urged by a spring so that the combustion chamber and the striking cylinder is closed, and opened against a spring force of the spring when an internal pressure in the combustion chamber is higher than an internal pressure in the striking cylinder; and
a check valve normally urged by a spring so that the combustion chamber and the striking cylinder is closed, and opened against a spring force when the internal pressure in the striking cylinder is higher than the internal pressure in the combustion chamber.

3. The gas combustion type striking tool according to claim 1,
wherein the valve mechanism includes:
a cylinder valve normally urged by a spring so that the combustion chamber and the striking cylinder is closed, and opened against a spring force of the spring when an internal pressure in the combustion chamber is higher than an internal pressure in the striking cylinder;
a hook member capable of engaging with the cylinder valve; and
a pushing member for pushing the hook member at the time of striking so that the hook member is engaged with the cylinder valve and separating from the hook member after the completion of striking.

4. The gas combustion type striking tool according to claim 1,
wherein the valve mechanism including a cylinder valve for opening and closing the combustion chamber and the striking cylinder, and
wherein the valve mechanism electrically controls an operation of the cylinder valve so that the cylinder valve is linked with the combustion in the combustion chamber and a returning motion of the striking cylinder after the completion of striking.
